(19) United States
(12) Patent Application Publication
(10) Pub. No.: US 2025/0317677 A1
(43) Pub. Date: Oct. 9, 2025

(54) MICROPHONE MOUNT ASSEMBLY

(71) Applicant: Louchen IP, LLC, Campbell, CA (US)

(72) Inventor: Brian A Loudenslager, San Jose, CA (US)

(21) Appl. No.: 19/173,260

(22) Filed: Apr. 8, 2025

Related U.S. Application Data
(60) Provisional application No. 63/631,033, filed on Apr. 8, 2024.

(51) Int. Cl. H04R 1/08; F16B 2/12; F16M 11/20; G10D 13/10

(52) U.S. Cl. CPC H04R 1/08; F16B 2/12; G10D 13/10; F16M 11/2035; F16M 2200/022; H04R 2201/025

(57) ABSTRACT

A microphone mount assembly includes a clamp and an articulated arm. The articulated arm is configured to receive a microphone positioned near a musical instrument for amplifying the sound. The clamp is configured to be attached to the musical instrument. The clamp includes a first jaw, a second jaw, and a jaw frame. The first jaw and the second jaw extend parallelly from the jaw frame and are asymmetrical and offset from one another. The first jaw includes a first dampening pad having a concave indentation. The second jaw includes a second dampening pad having a notched indentation. The first dampening pad and the second dampening pad are configured to be in contact with the musical instrument and avoid physical damage to the musical instrument. The first dampening pad and the second dampening pad are configured to reduce or eliminate vibrations from the musical instrument reaching the microphone.

### CROSS-REFERENCE TO RELATED APPLICATIONS

The present application claims priority under 35 U.S.C. § 119 (e) of U.S. Provisional Application Ser. No. 63/631,033, filed Apr. 8, 2024, and titled “Microphone Mount Assembly”. U.S. Provisional Application Ser. No. 63/631,033 is herein incorporated by reference in its entirety.

### BACKGROUND

Microphones are devices that receive sound waves and convert them into electrical signals. The electrical signals can then be processed, stored or transmitted for various purposes. The music industry is one of the many applications of microphones. For example, microphones are used in concert halls, public events, venues, recording studios, among others. In addition, microphones can be mounted on stands and/or holders to place the microphones as close as possible to video equipment, music instruments, and the like.

### DRAWINGS

The Detailed Description is described with reference to the accompanying figures. The use of the same reference numbers in different instances in the description and the figures may indicate similar or identical items.

FIG. 1 is a perspective view illustrating a clamp and an articulated arm for a microphone mount assembly in accordance with example embodiments of the present disclosure.

FIG. 2 is an isometric view illustrating a clamp, such as the clamp illustrated in FIG. 1, in accordance with example embodiments of the present disclosure.

FIG. 3 is a side view of a clamp, such as the clamp illustrated in FIG. 2, in accordance with example embodiments of the present disclosure.

FIG. 4 is a side view illustrating a microphone mount assembly, such as the microphone mount assembly illustrated in FIG. 1, mounted on a drum in accordance with example embodiments of the present disclosure.

FIG. 5 is a side view illustrating a microphone mount assembly, such as the microphone mount assembly illustrated in FIG. 4, mounted on a bottom hoop of the drum in accordance with example embodiments of the present disclosure.

### DETAILED DESCRIPTION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

### Overview

Microphones are commonly used to amplify or record live musical performances that involve sound sources, such as musical instruments. An audio or sound engineer has the task of configuring and placing the microphones adjacent or proximate (e.g., as close as possible) to the sound sources in order to improve the performance of the microphones. This may involve mounting or attaching microphones to a variety of surfaces and hardware, including microphone stands, drum hardware, amplifier cabinets, music stands, or to other clamping surfaces.

When using a microphone with a drum, a microphone stand might be used to position and hold the microphone in place. Free standing microphone stands may used, but the stands are easily knocked over by the performers. In addition, the stands are placed at fixed points and generally too far away from the drum skins, resulting in limited capturing of the sounds by the microphones.

Traditional drum mounting devices are limited in their ability to effectively position the sound capturing end of the microphone at various locations near the batter head surface of the drum. Mounting devices include clamps that are used to hold the mounting device tightly together with the drum. The clamps may include two jaws, such as a top jaw and a lower jaw. Typically, the top jaw and the lower jaw are symmetrical. As a result, the top jaw stays in contact with the batter head of the drum causing the drum to go out of tune. The lower jaw may stay in contact with the shell of the drum, causing physical damage to the drum over time. Additionally, the contact areas where the clamps engage with the drums are commonly made of plastic or metal. This may cause scratches or damage to the rim of the drum and create vibrations that are detected by the microphone and that produces noise or adverse rumble in the microphone. Moreover, most drum mounting devices allow the microphone to counter move as the drum starts to bounce around during use, from both direct and indirect contact. As a result, the direction of the microphone with respect to the drum may change, causing the captured sound to also change.

Accordingly, the present disclosure is directed to a microphone mount assembly for mounting a microphone that permits the sound capturing end of the microphone to be adjusted such that it may be placed adjacent to a wide variety of locations along or near the surface (batter head) of the drum. The microphone mount may include a clamp to quickly and easily use and adjust the mount. The microphone mount assembly may include asymmetrical and offset jaws. Additionally, the clamp may include a dampening features to avoid extraneous noise or vibrations from reaching the microphone.

The microphone mount assembly described herein may be securely attached to a musical instrument or sound source. For example, the microphone mount assembly may be attached to a drum. Additionally, a microphone may be mounted to the microphone mount assembly to receive sound from the musical instrument. According to an aspect of the disclosure, the microphone mount assembly may be configured to directly mount the microphone to drum rims.

According to another aspect of the disclosure, the microphone mount assembly comprises an articulated arm that includes a microphone attachment configured to receive the microphone.

According to another aspect of the disclosure, the microphone mount assembly comprises a clamp coupled to the articulated arm. The clamp includes a jaw frame, a first jaw and a second jaw, and the first jaw and the second jaw extend parallelly from the jaw frame. Additionally, the first jaw and the second jaw further include a first dampening pad and a second dampening pad, respectively.

According to another aspect of the disclosure, the first jaw and the second jaw are asymmetrical and offset from one another and are configured to receive the drum rim. The first dampening pad and the second dampening pad are configured to prevent damage to the drum. Additionally, the first dampening pad and the second dampening pad are configured to be in contact with the drum rim and avoid any vibration from reaching the microphone.

According to another aspect of the disclosure, the microphone mount assembly includes a combination of features described herein. The microphone mount assembly includes an articulated arm and a clamp. The articulated arm allows a microphone, connected to an end of the articulated arm, to be positioned as close as possible to the surface of the drum. The articulated arm is coupled to the clamp. Once the position of the articulated arm with respect to the clamp is tightened, the articulated arm and the clamp become rigid. Additionally, the clamp includes two jaws that are asymmetrical and offset from each other. As a result, the jaws are further offset with respect to the batter head and the shell of the drum. This prevents any damage or scratches to the drum. Each of the two jaws may include a dampening pad made of a dampening material (e.g., rubber) that prevents damage to the rim of the drum. The hardness and thickness of the dampening pads prevent noise or adverse rumble in the microphone (e.g., produced by vibrations from the drum) to reach the microphone. The hardness of the dampening pads also prevents the microphone mount assembly from moving out of position (e.g., wiggle) and countering the movement of the drum.

### Detailed Description of Example Embodiments

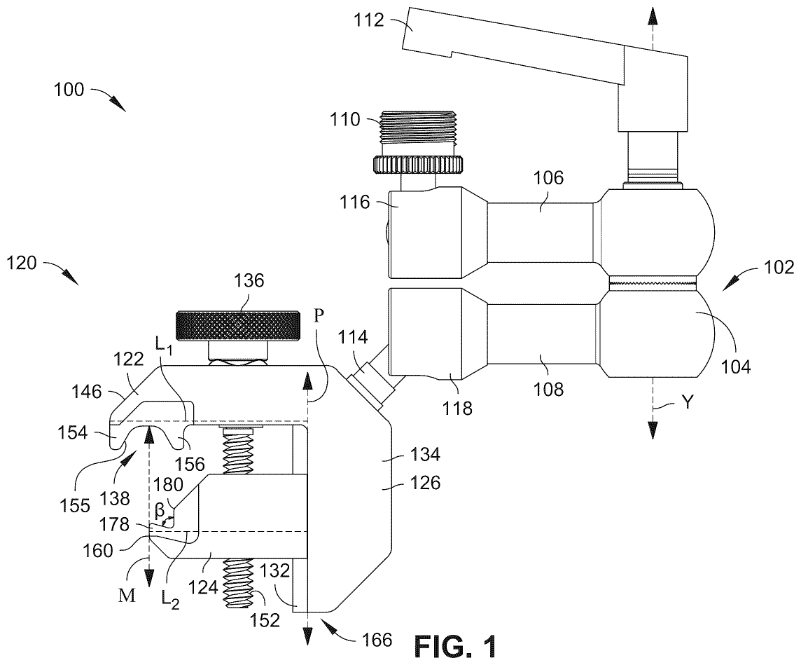

Referring generally to FIGS. 1 through 5, microphone mount assemblies are described in accordance with example embodiments of the present disclosure. Referring to FIG. 1, the microphone mount assembly 100 includes an articulated arm 102 and a clamp 120. The articulated arm 102 further includes a joint 104, a first member 106, a second member 108, a lever 112, a first swivel joint 116, and a second swivel joint 118.

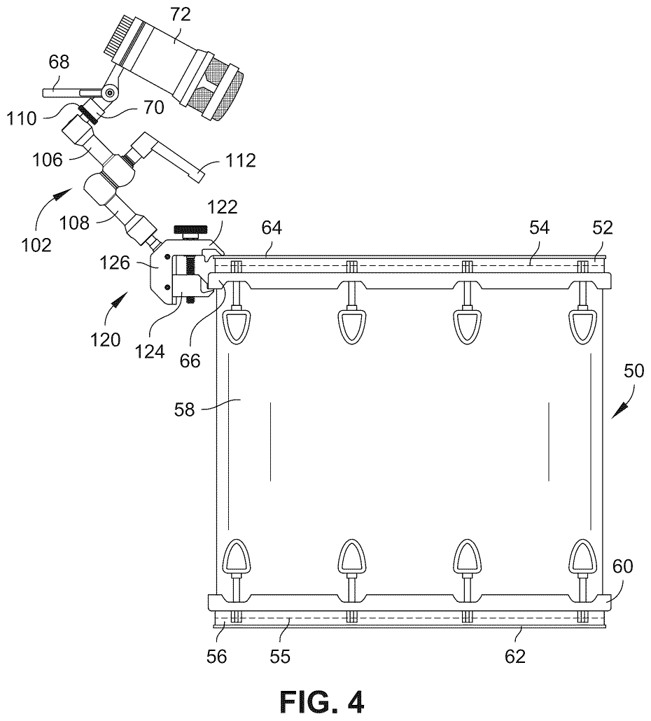

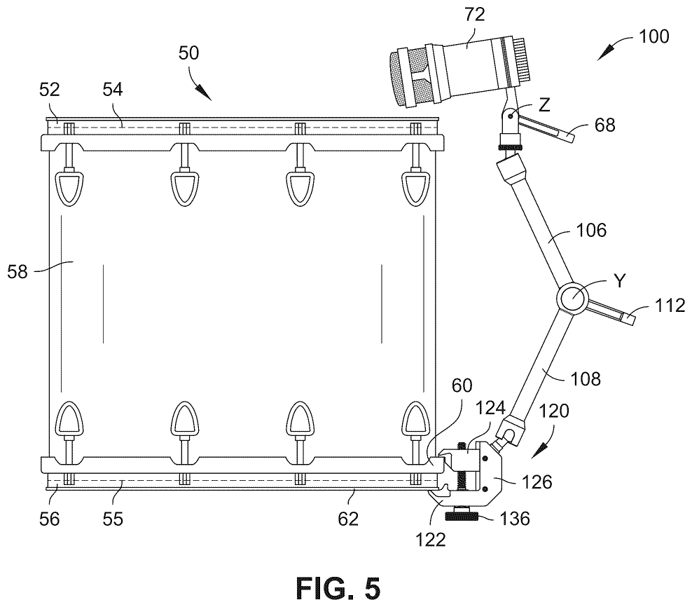

The clamp 120 includes a first jaw 122, a second jaw 124, a jaw frame 126, and a jaw knob 136. One end of the second swivel joint 118 includes an articulated arm nut 114 for coupling the articulated arm 102 to the clamp 120 at the jaw frame 126. One end of the first swivel joint 116 includes a microphone attachment 110 that is configured to receive a microphone mount 70. The microphone mount 70 includes a microphone lever 68 and a microphone 72. The first member 106 and the second member 108 are attached to the joint 104. In embodiments, the first member 106 and second member 108 can freely rotate three-hundred and sixty degrees (360°) about an axis Y. The position of the first member 106 and the second member 108 may be locked solidly into place at once by tightening the lever 112. In a similar way, the position of the first member 106 and second member 108 may be changed to another desired position by first loosening the lever 112 and tightening again once the desired position is achieved. Loosening of the microphone lever 68 (See FIGS. 4 and 5) may allow the microphone 72 to freely rotate one-hundred and eighty degrees) (180° about an axis Z. Conversely, tightening of the microphone lever 68 causes the microphone 72 to be positioned and secured at a desired angle about the axis Z.

As described above, by loosening the lever 112, the first member 106 and/or the second member 108 may be rotated about the joint 104 so that the first member 106 and second member 108 can be positioned next to each other (as shown in FIG. 1), completely extended in opposite directions (as shown in FIG. 4), or in between (as shown in FIG. 5). As shown in FIG. 4, the microphone attachment 110 includes a threaded stud portion that is configured to receive any standard professional audio microphone mount that has female mating threads, such as the microphone mount 70. In other embodiments, the microphone attachment 110 may be configured to receive a microphone mount having male mating threads.

The first swivel joint 116 is attached to the first member 106. The first swivel joint 116 has a ball shape that allows three-hundred and sixty degrees (360°) of rotation of the microphone attachment 110 for positioning the microphone mount 70 (not shown) in any desired direction and angle with respect to the articulated arm 102. As described above, the articulated arm nut 114 is located in one end of the second swivel joint 118. The articulated arm nut 114 is coupled to the clamp 120. Another end of the second swivel joint 118 has a ball shape that allows three-hundred-and-sixty degrees (360°) of rotation of the articulated arm 102 (e.g., in any desired direction and/or angle) with respect to the clamp 120. This allows for the microphone 72 to be in close proximity and to directly face the batter head 54. This positioning enables the acoustic signal from the vibrating batter head 54 to be sensed with a large signal to noise ratio.

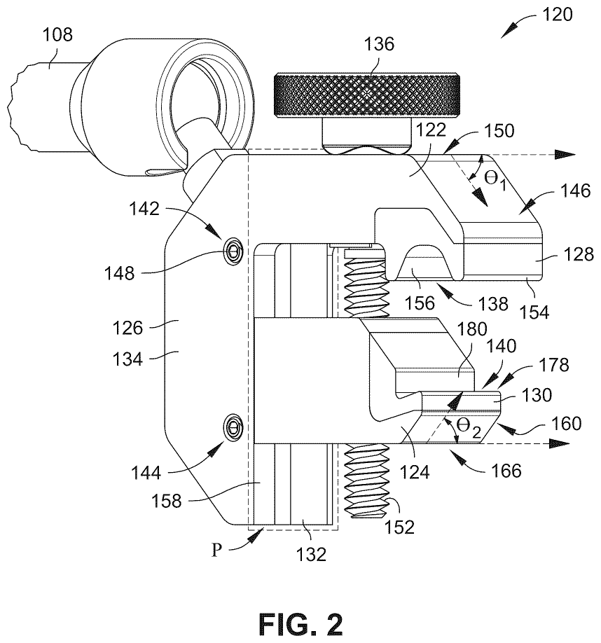

Referring to FIG. 2, the jaw frame 126 includes a guide 132 that provides a surface on which the second jaw 124 rides as the second jaw 124 is moved along the jaw frame 126. The jaw knob 136 also includes a threaded stud portion 152 that passes through the first jaw 122 and the second jaw 124. Rotation of the jaw knob 136 moves the second jaw 124 up and down along the guide 132 with respect to the jaw frame 126.

The jaw frame 126 may include a side surface 134 and an inside surface 158. The side surface 134 further includes a first set screw hole 142 and a second set screw hole 144. In this example embodiment, a set screw 148 is positioned within the first set screw hole 142. The first set screw hole 142, the second set screw hole 144 and the set screw 148 will be described in more detail below. In example embodiments, the guide 132 extends from a plane P that is coplanar with the inside surface 158 of the jaw frame 126. The guide 132 also extends from the first jaw 122 to a bottom side of the jaw frame 126.

In example embodiments, the first jaw 122 and the second jaw 124 extend parallel to each other from the jaw frame 126. Additionally, the first jaw 122 and second jaw 124 extend perpendicularly from the plane P. The first jaw 122 has a length L1 that extends from the plane P to the first end 146 of the first jaw 122. The second jaw 124 has a length L2 that extends from the plane P to the first end 160 of the second jaw 124. In the embodiments shown in FIG. 1, length L1 is longer than length L2 (e.g., in inches, centimeters, millimeters, etc.). In other embodiments (not shown) length L1 may be shorter than or equal to L2).

The first jaw 122 includes a first dampening pad 128 in a first end 146 of the first jaw 122. The first dampening pad 128 further includes a concave indentation 138, a first protrusion 154, and a second protrusion 156. The second jaw 124 includes a second dampening pad 130 at a first end 160 that is opposite to the jaw frame 126. The second dampening pad 130 also includes a notched indentation 140 that further includes a base wall 178 and a back wall 180. The back wall 180 may be generally vertical or parallel with respect to the plane P. The base wall 178 extends from the back wall 180 and forms an angle β with respect to the back wall 180. The angle β may be between zero degrees) (0° and eighty-nine degrees (89°). In embodiments, the angle β is an acute angle, for example, between thirty-five degrees) (35° and eighty-five degrees) (85°. In example embodiments, the angle β is between forty-five degrees) (45° and seventy degrees) (70°. A line M is tangential to the base wall 178. Line M generally bisects or passes through a midpoint of the first dampening pad 128 (e.g., the concave indentation 138). In embodiments, the outermost end of the base wall 178 is greater than or equal to the first end 160 of the second jaw 124. In embodiments, the base wall 178 does not extend beyond the line M. In other embodiments, the base wall 178 does not extend beyond an inner surface 155 of the first protrusion 154.

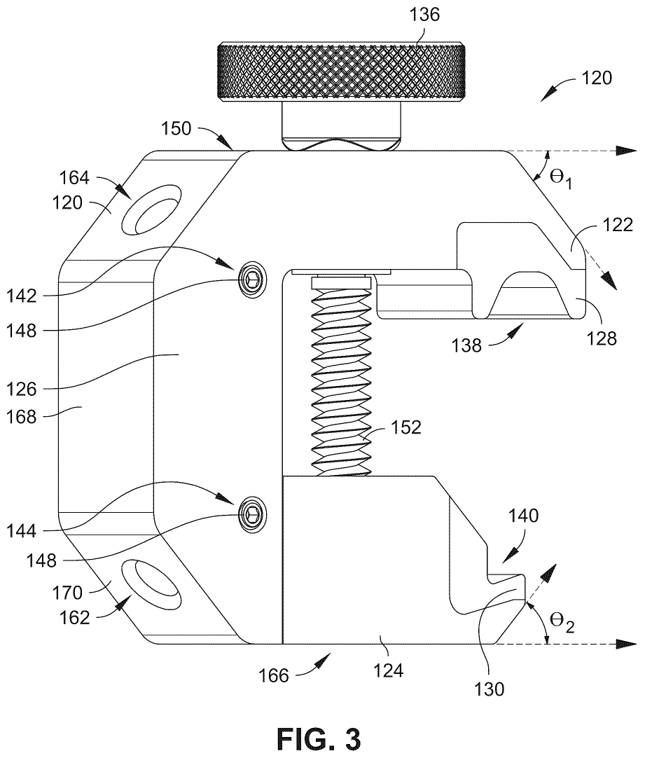

Referring to FIG. 3 the clamp 120 is described in more detail. The jaw frame 126 includes a first back surface 168, a second back surface 170, and a third back surface 172. The third back surface 172 further includes a first positioning hole 162. The second back surface further includes a second positioning hole 164. The first positioning hole 162 and the second positioning hole 164 will be described in more detail below. Referring again to FIGS. 2 through 4, rotation of the jaw knob 136 imparts rotation on the threaded stud portion 152 that causes the second jaw 124 to move relative to the first jaw 122 to either tighten or loosen the clamp 120 (e.g., with respect to the drum rim 52). In some embodiments, the first jaw 122 is a rigid component that extends into the jaw frame 126, in other words, the first jaw 122 is fixedly connected to the jaw frame 126, making the jaw frame 126 and the first jaw 122 a single component. In some embodiments, the second jaw 124 is a rigid component and a movable jaw that is user-actuated by rotating the jaw knob 136, as described above. In another embodiment, the first jaw 122 is a movable jaw and the rotation of jaw knob 136 causes the first jaw 122 and the second jaw 124 to move towards each other, pressing against the clamping surface (e.g., drum rim 52). In embodiments, the first jaw 122, the second jaw 124 and the jaw frame 126 are made of a metal, such as iron, stainless steel, aluminum, and/or a combination thereof, among others. In some embodiments, the first jaw 122, the second jaw 124 and the jaw frame 126 are made of a nonmetal material, such as a polymer or wood.

The first end 146 of the first jaw frame 122 may include a downward slope at an angle θ₁. The angle θ₁ may be between zero degrees) (0° and ninety degrees) (90° with respect to a top surface 150 of the first jaw 122. In some embodiments, the angle θ₁ may be between forty degrees) (40° and sixty degrees) (60°. Additionally, the first end 160 of the second jaw frame 124 includes an upward slope at an angle θ₂. The angle θ₂ may be between zero degrees) (0° and ninety degrees) (90° with respect to a bottom surface 166 (shown in FIG. 5) of the second jaw 124. In some embodiments, the angle θ₂ may be between forty degrees) (40° and sixty degrees) (60° with respect to the bottom surface 166.

In embodiments, the second jaw 124 includes the bottom surface 166 and defines a slot (not shown). The slot guides the second jaw 124 when traveling along the guide 132 relative to the first jaw 122 (e.g., when loosening or tightening the jaw knob 136). The first positioning hole 162 includes a threaded portion for receiving the articulated arm nut 114. Additionally, the second positioning hole 164 may also include a threaded portion that receives the articulated arm 102 by coupling the articulated arm nut 114 to the second positioning hole 164. The first set screw hole 142 also receives the set screw 148 for locking the articulated arm 102 into place and preventing the articulated arm 102 from vibrating and or loosening when the drum is being played.

As shown in FIGS. 4 and 5, the clamp 120 is configured to be attached to a drum rim 52 of a drum 50. The drum 50 includes the drum rim 52, a batter head 54, a resonant head 55, a bottom hoop 56, and a shell 58. For example, the first jaw 122 and second jaw 124 are coupled to the drum rim 52. The first dampening pad 128 and the second dampening pad 130 are configured to receive the drum rim 52.

In embodiments, the first dampening pad 128 and the second dampening pad 130 may be made of a dampening material that prevents the clamp 120 (e.g., the first jaw 122 and the second jaw 124) from scratching or damaging the drum rim 52. Additionally, the dampening material is configured to reduce and/or eliminate vibrations (e.g., have a decoupling effect) of the drum 50 from reaching and causing adverse noise (e.g., rumble) in the microphone 70. The thickness and/or hardness of the damping pad material is selected and predetermined to create the decoupling effect. In some embodiments, the dampening material is rubber such as natural or synthetic rubbers. In some embodiments, the hardness of the rubber ranges between 40 Shore A and 80 Shore A. In other embodiments, the dampening material is a polymer such as but not limited to thermoplastic elastomer (TPE), polyvinyl chloride (PVC), neoprene, chloroprene rubber (CR), styrene butadiene rubber (SBR), nitrile butadiene rubber (NBR), and/or ethylene propylene diene methylene (EPDM), either alone or in combination.

As shown in FIG. 4, the first dampening pad 128 is configured to be coupled to a top portion 64 of the drum rim 52. The second dampening pad 130 is coupled to a bottom portion 66 of the drum rim 52. For example, the concave indentation 138 of the first dampening pad 128 is configured to receive the top portion 64 of the drum rim 52 between the first protrusion 154 and the second protrusion 156. The notched indentation 140 of the second dampening pad 130 is configured to receive the bottom portion 66 of the drum rim 52.

The jaw knob 136 may be tightened in order to slide up the second jaw 124 through the guide 132. Consequently, the first jaw 122 and the second jaw 124 may be gripped down tighter on the top portion 64 and the bottom portion 66 of the drum rim 52, respectively. As shown in FIG. 4, the second jaw 124 is positioned at a distance away from the shell 58 of the drum 50 when the clamp 120 is in a mounted position. In other embodiments, the articulated arm 102 may be coupled to the jaw frame 126 by coupling the articulated arm nut 114 to the second positioning hole 164 of the jaw frame 126. Additionally, the first member 106 may be moved in any desired direction by rotating it against the second swivel joint 118.

As previously described, the first jaw 122 may firmly clamp onto the drum rim 52. The first jaw 122 is offset with respect to the batter head 54 approximately between one-fourth (¼) and three-fourths (¾) of the height of the drum rim 52 to prevent first jaw 122 to contact the batter head 54 and prevent the drum 50 from going out of tune. As described above, the first jaw 122 and the second jaw 124 (not shown) typically clamp to the drum 50 by tightening the jaw knob 132. Additionally, the jaw knob 132 allows to quickly clamp, tighten, and set up the microphone mount assembly 100 to the drum, as well as to quickly release and remove the microphone mount assembly 100 from the drum 50. The microphone mount 70 is securely attached to the articulated arm 110 and used to move the microphone 72 near the drum 50. The lever 112 is tightened when the desired position of the first member 106, the second member 108, and microphone mount 70 is achieved. Although FIG. 4 illustrates the microphone mount assembly 100 mounted on the drum rim 52 of the drum 50 to permit the sound capturing end of the microphone 72 to be positioned near the top surface of the batter head 54, the microphone mount assembly 100 may be positioned in other places.

Referring to FIG. 5, the microphone mount assembly 100 is coupled to the bottom hoop 56 of the drum 50. The bottom hoop 56 is located opposite from the drum rim 52. More specifically, the clamp 120 is coupled to the bottom hoop 56. Referring to FIG. 5, the articulated arm 110 is coupled to the clamp 120 by attaching the articulated arm nut 114 to the first positioning hole 162. In other embodiments, the microphone mount assembly 100 is configured to position the microphone 72 close to the resonant head 55 to amplify the sound produced by the resonant head 55 instead of the batter head 54. Similar to when the microphone 72 may be positioned in proximity to the batter head 54 with the clamp 120 coupled to either one of the drum rim 52 or the bottom hoop 56, the microphone 72 may be positioned in proximity to the resonant head 55 when the clamp 120 is coupled to either one of the drum rim 52 or the bottom hoop 56.

In example embodiments, the first member 106 and second member 108 may have different lengths, shapes, and/or sizes. For example, the first member 106 and the second member 108 shown in FIG. 5 have a length greater than the length shown in FIG. 4. The greater length allows the microphone 72 to be positioned near the top surface of the batter head 54.

In embodiments, the second jaw 124 is coupled to the top portion 60 of the bottom hoop 56 and the first jaw 122 is coupled to the bottom portion 62 of the bottom hoop 56. The second jaw 124 is offset with respect to the shell 58 approximately between one-fourth (¼) and three-fourths (¾) of the height of the drum rim 52, preventing the second jaw from causing friction onto the shell 58 and damaging of the drum 50 over time. The jaw knob 136 may be tightened so that the second jaw 124 slides through the guide 132. Consequently, the second jaw 124 and the first jaw 122 may be gripped down tighter on the top portion 60 and the bottom portion 62 of the bottom hoop 56, respectively. Additionally, the articulated arm 102 is coupled to the clamp 120 by attaching the articulated arm nut 114 to the jaw frame 126 (e.g., first positioning hole 162 shown in FIG. 4). The second set screw hole 144 receives the set screw 148 to lock the articulated arm 102 into place and prevent the articulated arm 102 from vibrating loose.

In operation, before the drum 50 is played by a drummer, the articulated arm 102 is secured within the clamp 120, and the lever 112 and the microphone lever 68 are tightened in order to position the microphone 72 as close as possible to the batter head 54 (or any other desired position). The articulated arm 102 and the clamp 120 become rigid. Additionally, the position of the microphone 72 with respect to the batter head 54 and the pointing direction of the microphone 72 is fixedly set. The hardness of the dampening pads 128, 130 prevents the microphone mount assembly 100 from moving out of the desired position. Additionally, the hardness of the dampening pads 128, 130 allows the microphone mount assembly 100 to follow the movement of the drum 50 which allows the microphone 72 to capture the sound from the set desired position at all times. This prevents a change of the position of the microphone 72 with respect to the batter head 54 that would cause a change in the sound that the microphone 72 is capturing.

In the preceding description, it is understood that terms such as “first,” “second,” “top,” “bottom,” “up,” “down,” and the like, are words of convenience and are not to be construed as limiting terms.

While the subject matter has been illustrated and described in detail in the drawings and foregoing description, the same is to be considered as illustrative and not restrictive in character, it being understood that example embodiments have been shown and described and that all changes and modifications that come within the spirit of the subject matters are desired to be protected. In reading the claims, it is intended that when words such as “a,” “an,” “at least one,” or “one of a plurality of” are used there is no intention to limit the claim to only one item unless specifically stated to the contrary in the claim. Unless specified or limited otherwise, the terms “mounted” and “connected” and variations thereof are used broadly and encompass both direct and indirect mountings, connections, and couplings. Further, “connected” is not restricted to physical or mechanical connections or couplings.

What is claimed is:

1. A microphone mount assembly configured to be mounted on a drum, the microphone mount assembly comprising:
a clamp configured to be coupled to an articulated arm, the clamp having a jaw frame; and
a first jaw integral with the jaw frame, and a second jaw moveable with respect to the first jaw along a guide formed in the jaw frame,
wherein an end portion of the first jaw includes a first dampening pad, wherein the first dampening pad includes a concave indentation,
wherein an end portion of the second jaw includes a second clamping pad, wherein the second dampening pad includes a base wall, and
wherein the base wall of the second dampening pad generally longitudinally aligns with a bisection of the concave indentation of the first dampening pad of the first jaw.

2. The microphone mount assembly of claim 1, wherein the jaw frame includes a first positioning hole and a second positioning hole, the first positioning hole and the second positioning hole disposed at opposite sides of the jaw frame from one another, and the articulated arm configured to couple to the jaw frame at one of the first positioning hole or the second positioning hole.

3. The microphone mount assembly of claim 2, wherein the jaw frame further includes a first set screw and a second set screw, the first set screw disposed proximate to the first positioning hole and configured to secure the articulated arm in the first positioning hole when the articulated arm is coupled to the first positioning hole, and the second set screw disposed proximate to the second positioning hole and configured to secure the articulated arm in the second positioning hole when the articulated arm is coupled to the second positioning hole.

4. The microphone mount assembly of claim 1, wherein the first jaw extends from the jaw frame to a length L1, and the second jaw extends from the jaw frame to a length L2, where L1 is greater than L2.

5. The microphone mount assembly of claim 1, wherein the first dampening pad further defines a first protrusion and a second protrusion, and the concave indentation is configured to receive a hoop top portion of a drum rim between the first protrusion and the second protrusion.

6. The microphone mount assembly of claim 1, wherein the second dampening pad further defines a back wall, where the base wall extends from the back wall and forms an acute angle, and where the notched indentation is configured to receive a hoop bottom portion of a drum rim.

7. A microphone mount assembly configured to be mounted on a drum, the microphone mount assembly comprising:
an articulated arm including a microphone attachment configured to be coupled to a microphone; and
a clamp coupled to the articulated arm, the clamp including a jaw frame, a first jaw and a second jaw, the first jaw and second jaw extending parallelly from the jaw frame and respectively including a first dampening pad and a second dampening pad;
wherein the first jaw and second jaw are asymmetrical and offset from one another and are configured to receive a drum rim in contact with the first dampening pad and the second dampening pad.

8. The microphone mount assembly of claim 7, wherein the jaw frame includes a first positioning hole and a second positioning hole, the first positioning hole and the second positioning hole disposed at opposite sides of the jaw frame from one another, and the articulated arm configured to couple to the jaw frame at one of the first positioning hole or the second positioning hole.

9. The microphone mount assembly of claim 8, wherein the jaw frame further includes a first set screw and a second set screw, the first set screw disposed proximate to the first positioning hole and configured to secure the articulated arm in the first positioning hole when the articulated arm is coupled to the first positioning hole, and the second set screw disposed proximate to the second positioning hole and configured to secure the articulated arm in the second positioning hole when the articulated arm is coupled to the second positioning hole.

10. The microphone mount assembly of claim 8, wherein the first jaw fixedly extends from the jaw frame in a direction opposite from the first positioning hole and the second positioning hole.

11. The microphone mount assembly of claim 7, wherein the first jaw extends from the jaw frame to a length L1, and the second jaw extends from the jaw frame to a length L2, where L1 is greater than L2.

12. The microphone mount assembly of claim 7, wherein the jaw frame includes a guide extending from the first jaw to a bottom side of the jaw frame, and wherein the second jaw is movable along the guide with respect to the first jaw.

13. The microphone mount assembly of claim 7, wherein the first dampening pad defines a first protrusion, a second protrusion, and a concave indentation the concave indentation configured to receive a hoop top portion of the drum rim between the first protrusion and the second protrusion.

14. The microphone mount assembly of claim 7, wherein the second dampening pad defines a notched indentation, the notched indentation including a back wall and a base wall, the base wall extending from the back wall and forming an acute angle, where the notched indentation is configured to receive a hoop bottom portion of the drum rim.

15. The microphone mount assembly of claim 7, wherein the first dampening pad defines a first protrusion, a second protrusion, and a concave indentation the concave indentation configured to receive a hoop top portion of the drum rim between the first protrusion and the second protrusion, and wherein the second dampening pad defines a notched indentation, the notched indentation including a back wall and a base wall, the base wall extending from the back wall and forming an acute angle, where the base wall extends to a line M and the line M bisects the concave indentation.

16. A microphone mount assembly configured to be mounted on a drum, the microphone mount comprising:
a clamp coupled to the articulated arm, the clamp including a jaw frame, a first jaw and a second jaw, the first jaw and second jaw extending parallelly from the jaw frame and respectively including a first dampening pad and a second dampening pad;
wherein the first jaw and second jaw are asymmetrical and offset from one another and are configured to receive a drum rim in contact with the first dampening pad and the second dampening pad.

17. The microphone mount assembly of claim 16, wherein the first jaw extends from the jaw frame to a length L1, and the second jaw extends from the jaw frame to a length L2, where L1 is greater than L2.

18. The microphone mount assembly of claim 16, wherein the jaw frame includes a guide extending from the first jaw to a bottom side of the jaw frame, and wherein the second jaw is movable along the guide with respect to the first jaw.

19. The microphone mount assembly of claim 16, wherein the first dampening pad defines a first protrusion, a second protrusion, and a concave indentation the concave indentation configured to receive a hoop top portion of the drum rim between the first protrusion and the second protrusion.

20. The microphone mount assembly of claim 16, wherein the second dampening pad defines a notched indentation, the notched indentation including a back wall and a base wall, the base wall extending from the back wall and forming an acute angle, where the notched indentation is configured to receive a hoop bottom portion of the drum rim.
